(19) United States
(12) Patent Application Publication
(10) Pub. No.: US 2013/0010829 A1
(43) Pub. Date: Jan. 10, 2013

(54) TEMPERATURE MEASURING PROBE, TEMPERATURE MEASURING APPARATUS, AND TEMPERATURE MEASURING METHOD

(75) Inventor: Kaoru Ojima, Kawasaki-shi (JP)

(73) Assignee: CANON KABUSHIKI KAISHA, Tokyo (JP)

(21) Appl. No.: 13/634,690

(22) PCT Filed: May 13, 2011
(86) PCT No.: PCT/JP2011/002668

§ 371 Date: Sep. 13, 2012

(30) Foreign Application Priority Data
May 19, 2010 (JP) 2010-115490

(51) Int. Cl. G01K 1/14

(52) U.S. Cl. 374/208; 374/E01.018

(57) ABSTRACT

A temperature measuring probe is characterized in that it has a film 4 on a part of a first surface of a cantilever 2 having an opening in the center, the film 4 is formed of a material different in coefficient of thermal expansion from the cantilever 2, it has a film 5 on a part of a surface of the cantilever 2 opposite to the first surface, the film 5 is formed of the same material as the film 4, and when the films 4 and 5 are projected onto a plane parallel to the cantilever 2, the projection image of the film 4 and the projection image of the film 5 do not coincide. Thus, a temperature measuring probe and a temperature measuring apparatus can be made that can be used with a general-purpose scanning probe microscope and is insusceptible to thermal deformation of a sample.

### TECHNICAL FIELD

The present invention relates to a probe for measuring temperature using a probe microscope, a temperature measuring apparatus, and a temperature measuring method.

### BACKGROUND ART

Known temperature measuring methods using a scanning probe microscope include a method using a thermocouple probe and a method using thermal change of a probe.

PTL 1 discloses a thermocouple probe in which a minute thermocouple in which dissimilar metals are joined is formed at the tip of a cantilever. By bringing this thermocouple probe into contact with a sample and measuring the thermoelectromotive force produced in the thermocouple, the temperature of a local region of the sample surface can be determined.

PTL 2 discloses a temperature measuring method using thermal change of a probe, in which temperature is determined from the change in the amount of bending of a cantilever due to bimetallic effect.

However, a method using the thermocouple probe disclosed in PTL 1 requires a probe holder and a dedicated measuring apparatus for measuring the thermoelectromotive force difference and is therefore difficult to use with a general-purpose machine.

The method using thermal deformation disclosed in PTL 2 has the advantage of being able to use a commercially available cantilever. However, the displacement due to thermal expansion of a sample is superimposed on the amount of bending of the cantilever, and therefore measures such as performing AC heating must be taken.

### CITATION LIST

### Patent Literature

PTL 1: Japanese Patent Laid-Open No. 8-105801
PTL 2: Japanese Patent Laid-Open No. 9-325079

### SUMMARY OF INVENTION

The present invention provides a temperature measuring probe that can be used with a general-purpose scanning probe microscope and is insusceptible to thermal deformation of a sample, and a temperature measuring apparatus and a temperature measuring method using the probe.

### Solution to Problem

In an aspect of the present invention, a temperature measuring probe includes a support member, a cantilever one end of which is supported by the support member and that has a closed ring structure, and a probe tip disposed at a tip of the cantilever. The cantilever has such a closed ring structure that two components extending from the support member to the probe tip unite at the tip of the cantilever. Films of a material different in coefficient of thermal expansion from the components of the cantilever are formed on a surface of one of the two components of the cantilever and on a surface of the other component on the opposite side from the surface.

Further features of the present invention will become apparent from the following description of exemplary embodiment with reference to the attached drawings.

### BRIEF DESCRIPTION OF DRAWINGS

FIG. 1A is a schematic view of a temperature measuring probe.

FIG. 1B is a schematic view of a temperature measuring probe.

FIG. 1C is a schematic view of a temperature measuring probe.

FIG. 2A shows a modification of a temperature measuring probe.

FIG. 2B shows a modification of a temperature measuring probe.

FIG. 3 is a schematic view of a temperature measuring apparatus.

FIG. 4 is a perspective view of a temperature measuring probe.

FIG. 5 is a graph showing the relationship between the sample temperature and the amount of twist displacement of a cantilever in a first embodiment.

### DESCRIPTION OF EMBODIMENT

The present invention relates to a temperature measuring probe for detecting temperature of a local region of a sample surface using the technology of scanning probe microscope, and a temperature measuring apparatus and a temperature measuring method using the same. The embodiment of the present invention will be specifically described with reference to the drawings. The present invention is not limited to the following drawings as long as the scope of the present invention is not exceeded.

### First Embodiment

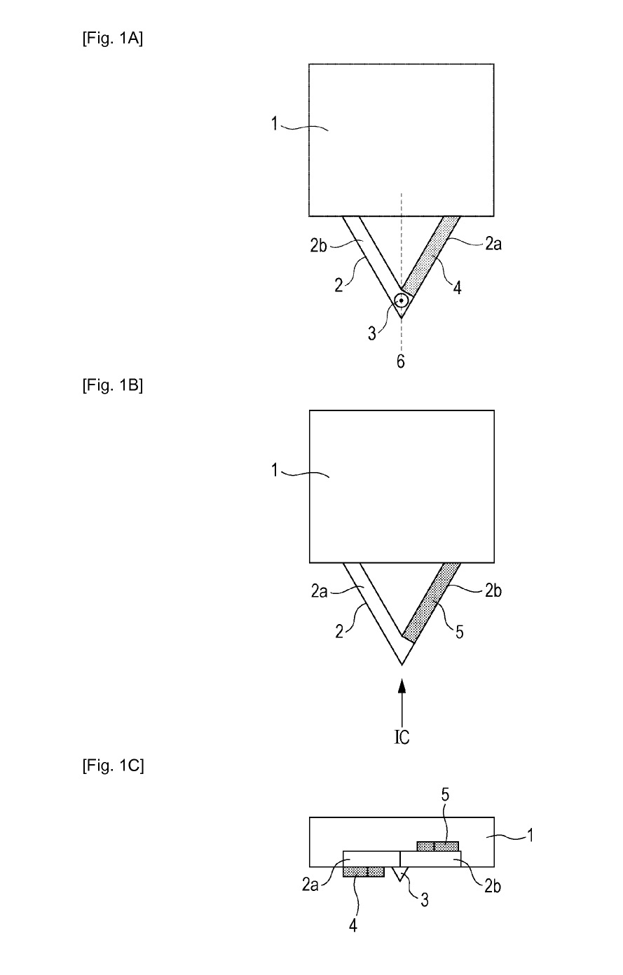

FIGS. 1A, 1B, and 1C are schematic views of a temperature measuring probe in a first embodiment. FIG. 1A is a plan view of the probe placed with its probe tip 3 up. FIG. 1B is a plan view of the probe placed with its probe tip 3 down. FIG. 1C is a side view as viewed from the direction of arrow IC of FIG. 1B.

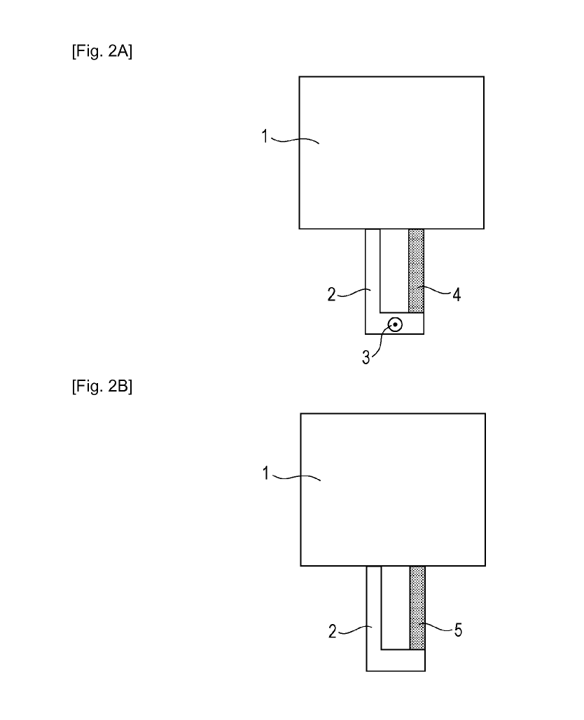

The probe includes a support member 1, a cantilever 2 one end of which is attached to the support member 1 and that has a closed ring structure, and a pointed probe tip 3 disposed at the tip of the cantilever 2. The cantilever 2 includes two components 2a and 2b that extend from the support member 1 to the probe tip 3 and unite at their ends. The probe tip 3 is disposed at the tip portion where the two components 2a and 2b unite. The support member 1, the cantilever 2, and the probe tip 3 can be made of silicon nitride or single-crystal silicon. The surfaces of the support member 1, the cantilever 2, and the probe tip 3 may be coated with a film of a metal such as gold, aluminum, platinum, or rhodium. The cantilever 2 can be bilaterally symmetric with respect to the support member 1. The cantilever 2 may be rectangular as shown in FIGS. 2A and 2B.

On the probe tip 3 side surface of the component 2a forming the cantilever 2, a film 4 of a material different in coefficient of thermal expansion from the components of the cantilever 2 is formed. On a surface of the component 2b on the opposite side from the probe tip 3, a film 5 of the same material as the film 4 is formed. The films 4 and 5 can be formed of a metal, ceramic, or organic material. The films 4 and 5 are formed using a vapor deposition method using a mask, a metal deposition method performed in a focused ion/electron beam processing and observation apparatus (FIB-SEM), or the like.

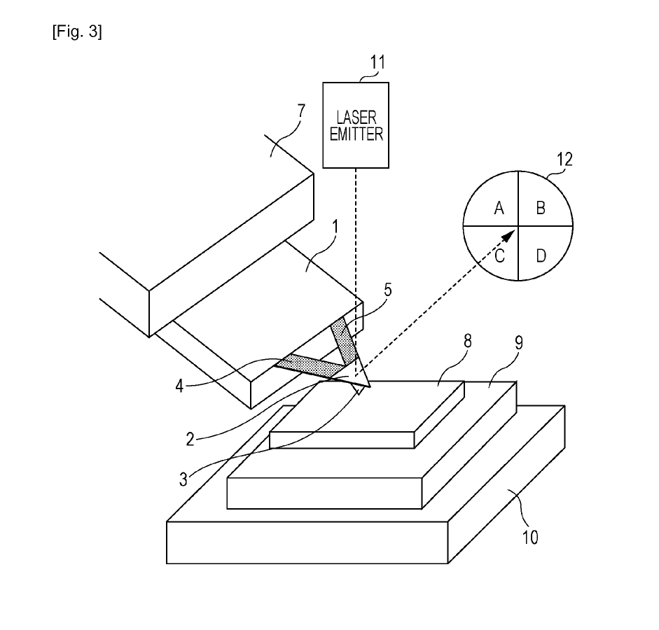

Next, a description will be given of the configuration of a temperature measuring apparatus when a temperature measuring cantilever is used in a scanning probe microscope. FIG. 3 is a schematic configuration diagram of a temperature measuring apparatus.

A temperature measuring probe is used with a support member 1 fixed to a probe holder 7. A sample 8 is fixed to a sample stage 9. The relative positions of the probe tip 3 and the sample 8 are changed using a drive stage 10. In FIG. 3, the drive stage 10 changes the position of the sample 8. However, the drive stage 10 may be integrated with the probe and may change the position of the probe tip 3.

Next, an embodiment of a temperature measuring method will be described in detail. A point on the sample surface where temperature is measured is preliminarily determined by observing the sample surface using an optical microscope or a scanning probe microscope.

First, the probe tip 3 and the sample 8 are brought into contact with each other using the drive stage 10. The contact condition is controlled by moving the sample 8 in order to keep the output of the photodetector 12 constant. The laser light emitted from a laser emitter 11 and reflected by the cantilever 2 is detected by photodetector 12. Usually, a detector divided into four parts: A-part, B-part, C-part, and D-part as shown in FIG. 3 is used as a photodetector 12. Let the amounts of light received by A-part, B-part, C-part, and D-part be denoted as A, B, C, and D, respectively. The contact pressure between the probe tip 3 and the sample 8 is maintained constant by controlling the drive stage 10 so that (A+B)−(C+D) is constant.

When the probe tip 3 comes into contact with the sample 8, the temperature of the cantilever 2 changes due to thermal conduction. When films are disposed on the cantilever 2 as shown in the embodiment of the temperature measuring probe of the present invention, the two parts of the cantilever 2 try to bend in opposite directions due to bimetallic effect. However, since the cantilever has a closed ring structure, a twist occurs. The twist of the cantilever 2 is detected with the photodetector 12. Initial setting is performed so that (A +C)−(B +D) is zero when the probe tip 3 and the sample 8 are out of contact with each other. When the probe tip 3 and the sample 8 come into contact with each other and a thermal equilibrium state is reached, (A +C)−(B +D) shows a constant value. The amount of twist will be defined as this value.

By preliminarily determining the correlation between the amount of twist and temperature, temperature measurement can be performed using the temperature measuring probe of the present invention.

### Example 1

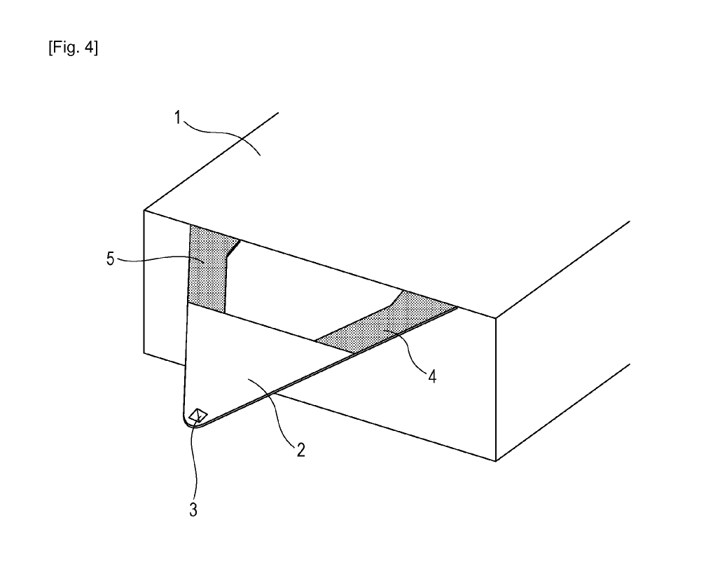

Example 1 of the present invention will be described with reference to the drawings. FIG. 4 is a perspective view of an example of a temperature measuring probe of the present invention. This probe was made by the following process.

In this example, a probe having a triangular cantilever 2 made of silicon nitride and coated with gold on both sides (SII NanoTechnology Inc., SN-AF01-A, spring constant 0.08 N/m) was used as a base of a probe.

Next, a small piece of silicon was attached to a sample holder for FIB-SEM, and the support member 1 of the probe was fixed on the small piece with the probe tip 3 up using a vacuum conductive tape. The small piece of silicon was used for preventing the cantilever coming into contact with the sample holder. After fixation, the probe was introduced into a FIB-SEM apparatus.

Next, the probe was observed with SEM in the FIB-SEM apparatus, and then a region where a film 4 was to be formed was selected in a part of one of the two components of the cantilever 2 extending from the support member 1 to the free end. In the selected region, a platinum film 50 nm thick was deposited using FIB. After the deposition of platinum, SEM observation was performed again, and it was checked that a film 4 was formed.

Next, this probe was taken out from the FIB-SEM apparatus and then fixed using a vacuum conductive tape in such a manner that the probe tip 3 did not collide with the small piece of silicon and faced downward. After fixation, the probe was introduced into the FIB-SEM apparatus.

Next, the probe was observed with SEM in the FIB-SEM apparatus, and then a region where a film 5 was to be formed was selected in a part of a surface opposite to the surface on which the film 4 was formed of the other of the two components of the cantilever 2 extending from the support member 1 to the free end. This region has the same shape as the film 4. In the selected region, a platinum film 50 nm thick was deposited using FIB. After the deposition of platinum, SEM observation was performed again, and it was checked that a film 5 was formed.

In this example, elemental analysis was performed on the films 4 and 5 with SEM-EDX, and it was checked that platinum was deposited in the selected regions. The temperature measuring probe shown in FIG. 4 was obtained by such a process.

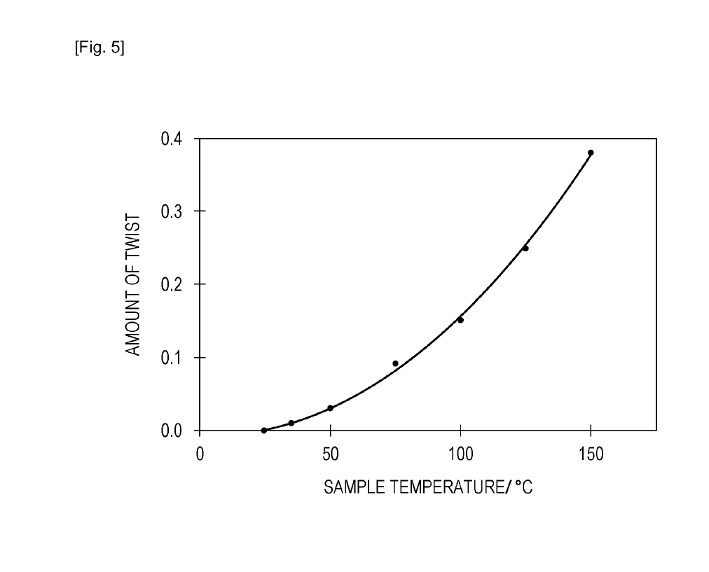

FIG. 5 shows a measurement example of sample temperatures measured using the temperature measuring probe of the embodiment shown in FIG. 4 and the amounts of twist of the cantilever. The horizontal axis shows sample temperature, and the vertical axis shows the amount of twist of the cantilever. This measurement was performed by the following procedure.

For measurement, a scanning probe microscope apparatus (SII NanoTechnology Inc., E-sweep) was used. The sample heating holder whose surface is made of copper was used as a sample, and the sample temperature was measured using the setting value of the heat regulator of the sample heating holder and a thermocouple brought into contact with the sample-mounting surface.

Using the scanning probe microscope apparatus, control was performed so that the amount of bending of the cantilever when the cantilever comes into contact with the sample was a constant value, and the probe was brought into contact with the sample surface. After coming into contact, the temperature of the cantilever rises due to the thermal conduction from the sample, and twist displacement occurs in the cantilever due to bimetallic effect. When the sample temperature is constant, the twist displacement is saturated at a constant value. The amount of twist at the temperature being measured will be defined as this saturation value. By changing the sample temperature and determining the amount of twist at each temperature, a correlation curve shown in FIG. 5 was obtained. This correlation curve is specific to the temperature measuring probe used for measurement. Therefore, it is possible to optically detect the amount of twist and to determine the temperature of the sample from the detected amount and a preliminarily-stored temperature value corresponding to the amount of twist of the cantilever.

The temperature measuring probe of the present invention does not require, for example, an electrode connecting terminal for temperature measurement and can therefore be used in a general-purpose probe microscope apparatus. By using the amount of twist of the cantilever for temperature measurement, the influence, for example, of the sample expansion on temperature measurement can be curbed.

While the present invention has been described with reference to exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-115490, filed May 19, 2010, which is hereby incorporated by reference herein in its entirety.

1. A temperature measuring probe comprising:
a support member;
a cantilever one end of which is supported by the support member and that has a closed ring structure; and
a probe tip disposed at a tip of the cantilever,
wherein the cantilever has such a closed ring structure that two components extending from the support member to the probe tip unite at the tip of the cantilever, and films of a material different in coefficient of thermal expansion from the components of the cantilever are formed on a surface of one of the two components of the cantilever and on a surface of the other component on the opposite side from the surface.

2. A temperature measuring apparatus comprising:
the temperature measuring probe according to claim 1;
a probe holder to which the temperature measuring probe is fixed;
a sample stage on which a sample to be measured is placed;
a drive stage that changes the relative positions of the temperature measuring probe and the sample stage; and
a detector configured to detect the displacement of the cantilever.

3. A temperature measuring method comprising the steps of:
pressing the probe tip of the temperature measuring probe according to claim 1 against a sample at a constant pressure;
optically detecting the twist of the cantilever; and
measuring the temperature of the sample from the detected amount and a preliminarily-stored temperature value corresponding to the amount of twist of the cantilever.
